(19) United States
(12) Patent Application Publication
(10) Pub. No.: US 2017/0147853 A1
(43) Pub. Date: May 25, 2017

(54) REFLECTION TYPE FINGERPRINT RECOGNITION DEVICE

(71) Applicant: CentraLED TECHNOLOGY CO., LTD., Taoyuan (TW)

(72) Inventors: Ching-Cherng SUN, Taoyuan (TW); Yeh-Wei YU, Taoyuan (TW); Jhih-You CAI, Taoyuan (TW); Yu-Yu CHANG, Taoyuan (TW)

(73) Assignee: CentraLED Technology Co., Ltd.

(21) Appl. No.: 15/357,196

(22) Filed: Nov. 21, 2016

Related U.S. Application Data
(60) Provisional application No. 62/257,866, filed on Nov. 20, 2015.

(51) Int. Cl. G06K 9/00

(52) U.S. Cl. CPC G06K 9/0002

(57) ABSTRACT

The present invention discloses a reflection type fingerprint recognition device, including a transparent layer, an optical sensor and at least two light sources, wherein each of the light sources being switched on in turn or emitting light of different frequency spectra or of different intensity from any other light source. With the implementation of the present invention, the following advantageous effects can be provided: structural simplicity to improve ease of manufacture and low manufacturing costs; reduction of space occupation enabling further applications; and maintaining same amount of information under same size of optical sensor to improve feature classification and reduce recognition error.

### BACKGROUND OF THE INVENTION

1. Technical Field

The present invention relates to a fingerprint recognition device, and more particularly to a reflection type fingerprint recognition device.

2. Description of Related Art

As can be seen in FIG. 1, in a known fingerprint recognition system 400, a prism 410 is used to rest a finger 800 in one surface and being illuminated by a light source 420 from another surface, the reflected light from the finger 800 is then collected by a collector structure placed near still another surface.

The fingerprint recognition system 400 as in FIG. 1 occupies huge space and can hardly commence fingerprint recognition. The main reason is that there is a divergence angle of every light source that makes the reflection light from the fingerprint divergent to different angles, besides, the thickness of the prism glass is different to have different magnifications makes the image information far from adequate for recognition.

Besides, the reserved room/space for fingerprint recognition system or devices in modern portable devices, such as smart phones or lap tops, is quite small due to the necessity of adopting enough thickness for protection glass on the display screen.

In view of the above mentioned drawbacks of prior art fingerprint recognition devices and the constant growing needs of fingerprint recognition parts or system built inside portable devices, it is therefore highly desirable to have the development of high contrast, high reflection type fingerprint recognition system and to further promote application fields.

### BRIEF SUMMARY OF THE INVENTION

The present invention discloses a reflection type fingerprint recognition device, including a transparent layer, an optical sensor and at least two light sources, wherein each of the light sources being switched on in turn or emitting light of different frequency spectra or of different intensity from any other light source. With the implementation of the present invention, the following advantageous effects can be provided: structural simplicity to improve ease of manufacture and low manufacturing costs; reduction of space occupation enabling further applications; and maintaining same amount of information under same size of optical sensor to improve feature classification and reduce recognition error.

The present invention provides a reflection type fingerprint recognition device, used to sense or recognize a fingerprint, comprising: a transparent layer, being made of light transmitting substance, a fingerprint of a finger to be recognized being placed on a first surface of the transparent layer; an optical sensor, fixedly provided beside and without touching a second surface of the transparent layer, wherein the second surface is opposite to the first surface; and at least two light sources, fixedly provided beside the second surface, wherein the light transmitted from the light sources penetrates the transparent layer and illuminates the fingerprint.

Implementation of the present invention at least provides the following advantageous effects:

1. Structure simplicity to improve ease of manufacturing and low manufacturing costs.

2. Reduction of space occupation enabling further applications.

3. Maintaining same amount of information under same size of optical sensor to improve feature classification and reduce recognition error.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a prior art reflection type fingerprint recognition device.

FIG. 2A is a perspective sectional view of a reflection type fingerprint recognition device in an embodiment of the present invention.

FIG. 2B is a perspective top view of the embodiment of FIG. 2A.

FIG. 3A is a perspective sectional view of the embodiment of FIG. 2A when one of the light source is on.

FIG. 3B is a perspective top view of the embodiment of FIG. 3A.

FIG. 3C is a perspective view of a fingerprint image obtained in the embodiment of FIG. 3A.

FIG. 4A is a perspective sectional view of the embodiment of FIG. 2A when another light source is on.

FIG. 4B is a perspective top view of the embodiment of FIG. 4A.

FIG. 4C is a perspective view of a fingerprint image obtained in the embodiment of FIG. 4A.

FIG. 5 is a perspective view of a combined image of the fingerprint images of FIG. 3C and FIG. 4C.

FIG. 6A is a perspective sectional view of a reflection type fingerprint recognition device that comprises 4 light sources in an embodiment of the present invention.

FIG. 6B is a perspective view of the timing diagrams and related fingerprint images using each timing diagram to sequentially turn on the light sources in the embodiment of FIG. 6A.

FIG. 6C is a perspective view of a combined image of the fingerprint images of FIG. 6B.

FIG. 7A is a perspective view of a light source emitting light of a spectrum and the fingerprint image taken in an embodiment of the present invention.

FIG. 7B is a perspective view of another light source emitting light of another spectrum and the fingerprint image taken in an embodiment of the present invention.

FIG. 7C is a perspective view of a combined image of the fingerprint images of FIG. 7A and FIG. 7B.

FIG. 8 is a perspective view of a processed fingerprint image from the fingerprint images as in FIG. 7C.

FIG. 9 is another timing diagram for the reflection type fingerprint recognition device as in FIG. 6A in an embodiment of the present invention.

FIG. 10 is a perspective sectional view of a reflection type fingerprint recognition device further comprises at least two blocking boards in an embodiment of the present invention.

FIG. 11A is a perspective view of a magnification modified fingerprint image in an embodiment of the present invention.

FIG. 11B is a perspective view of another magnification modified fingerprint image in an embodiment of the present invention.

FIG. 12 is a perspective view of a combined image of the fingerprint images of FIG. 11A and FIG. 11B.

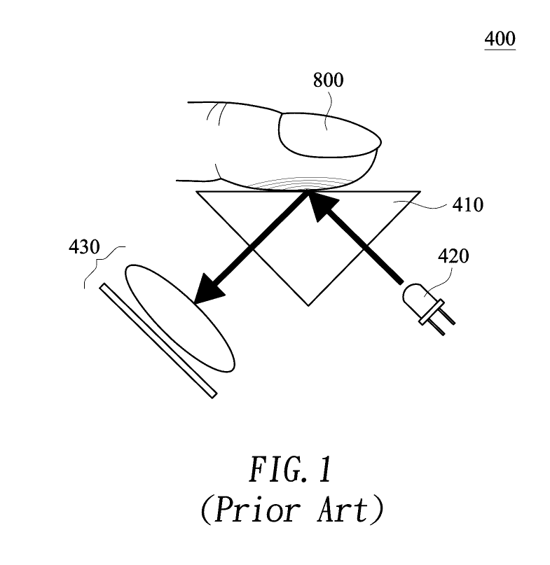

### DETAILED DESCRIPTION OF THE INVENTION

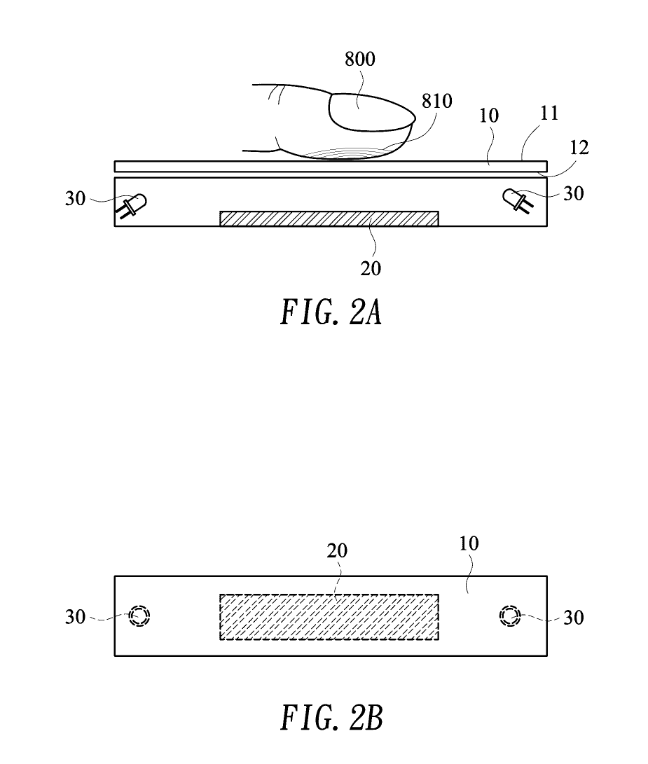

Please refer to FIG. 2A and FIG. 2B, is a reflection type fingerprint recognition device 100 in an embodiment of the present invention, it includes a transparent layer 10, an optical sensor 20 and at least two light sources 30.

As shown in FIG. 2A and FIG. 2B, transparent layer 10 is a board or a film made of transparent material, such as glass. The finger 800 with fingerprint 810 to be detected rests on the first surface 11 of the transparent layer 10.

As shown in FIG. 2A and FIG. 2B, an optical sensor 20 fixedly provided beside and without touching a second surface 12 of the transparent layer 10, wherein the second surface 12 is opposite to the first surface 11.

The optical sensor 20 can be composed of one or more CMOS sensor chip or CCD sensor chip.

As also shown in FIG. 2A and FIG. 2B, at least two light sources 30, fixedly provided beside the second surface 12, wherein the light transmitted from the light sources 30 penetrates the transparent layer 10 and illuminates the fingerprint 810 of the finger 800.

Any of the light sources 30 can be a LED or a laser diode (LD).

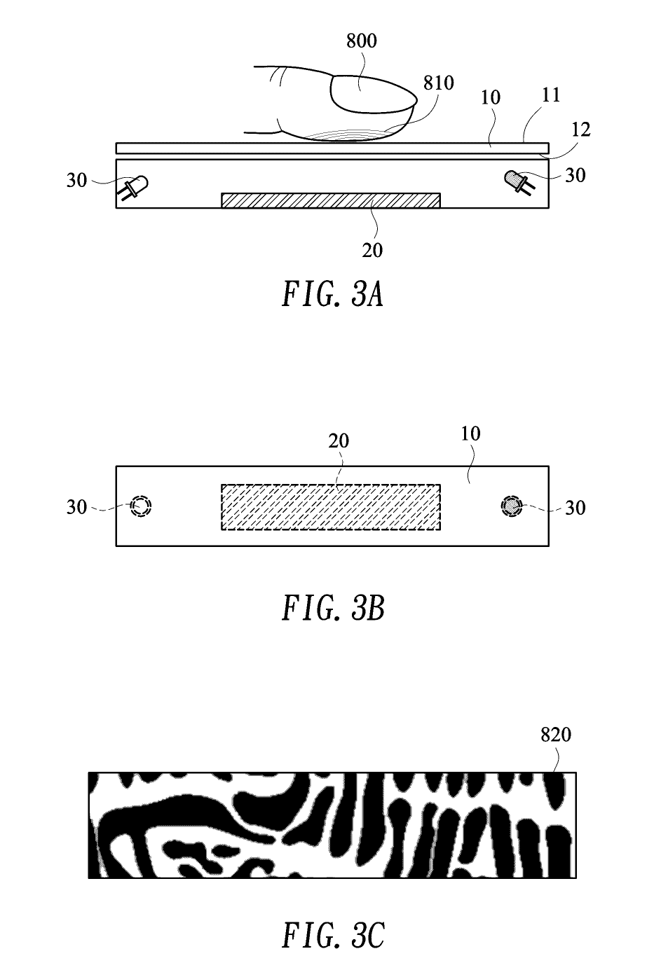

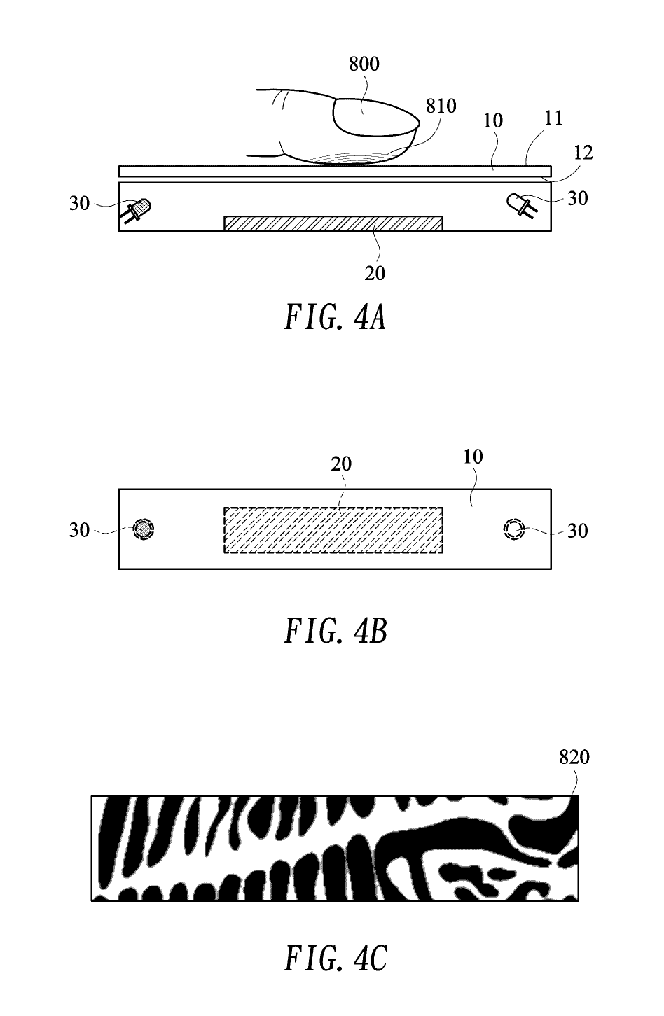

Please refer now to FIG. 3A to FIG. 4C, to improve the insufficient amount of information due to magnification, the number of the light sources 30 is two or more than two, each of the light sources 30 is turned on in a time multiplexing sequence and the optical sensor 20 detects and generates a fingerprint images 820 of the finger 800 when illuminated by each light source 30.

As shown in FIG. 3A and FIG. 3B, the light signal reflected from a fingerprint 810 illuminated by a light source 30 of the reflection type fingerprint recognition device 100 is detected by the optical sensor 20 and a fingerprint image 820 as in FIG. 3C is generated.

Referring to FIG. 4A and FIG. 4B, another light source 30 of the reflection type fingerprint recognition device 100 is turned on, and only that light source 30 is turned on, the light signal reflected from a fingerprint 810 is detected by the optical sensor 20 and a fingerprint image 820 as in FIG. 4C is generated.

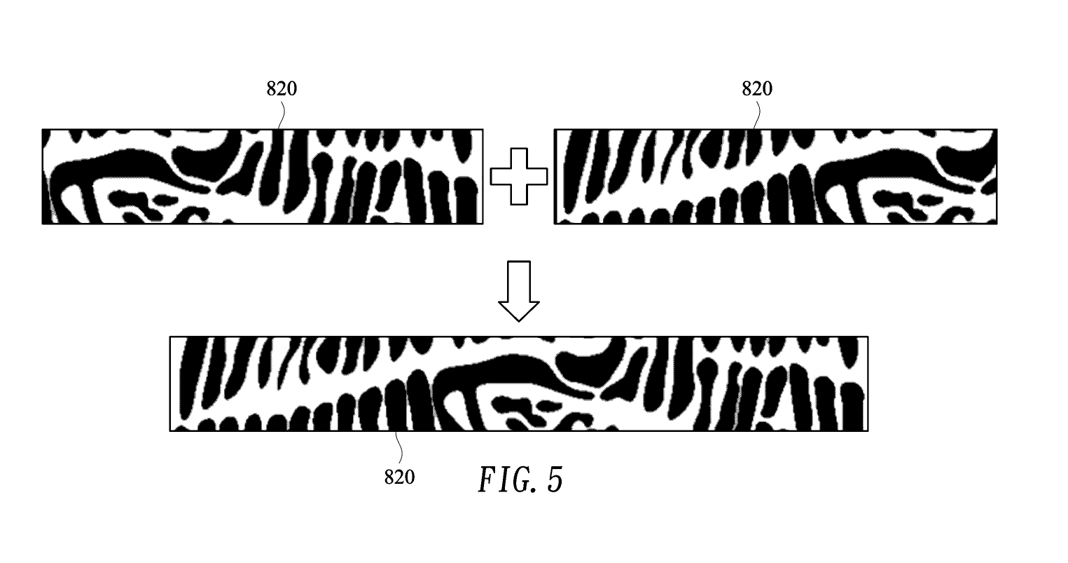

Referring now to FIG. 5, the fingerprint images 820 of FIG. 3C and FIG. 4C illuminated by different light sources 30 from different angles can then be combined to generate a complete fingerprint image 820 by the optical sensor 20 or a foreign processor unit.

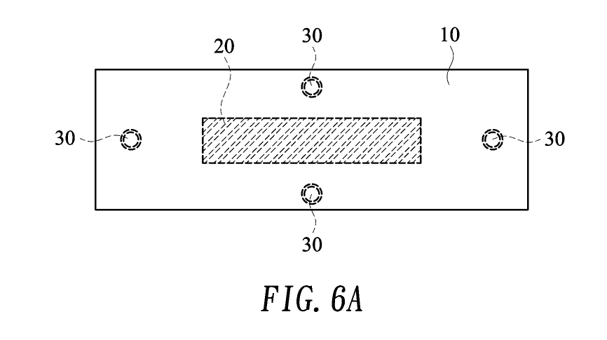

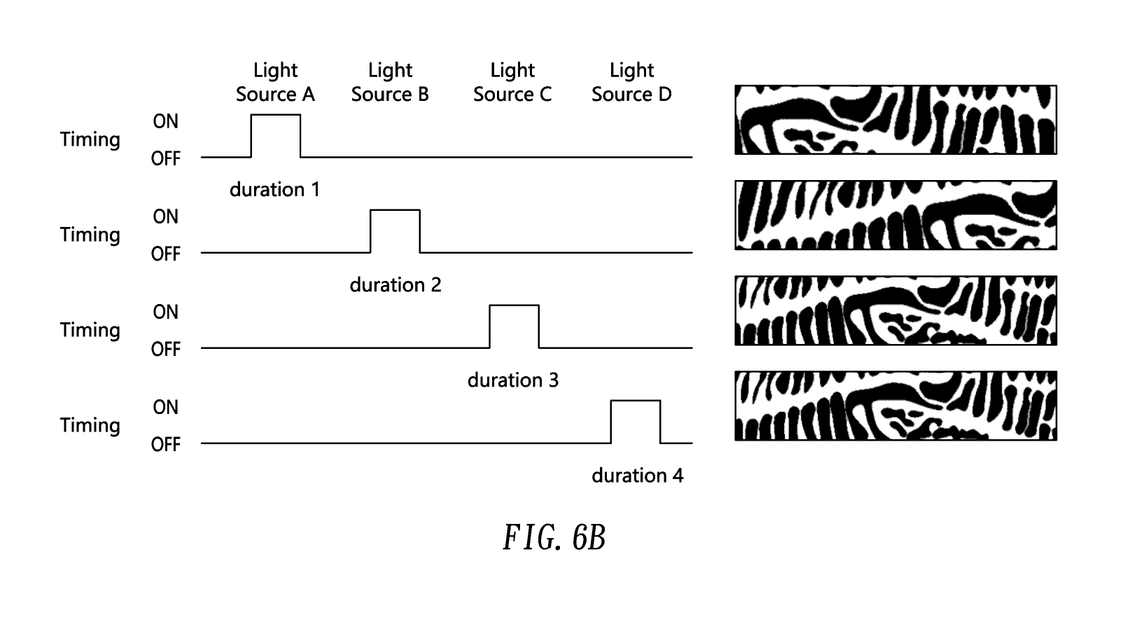

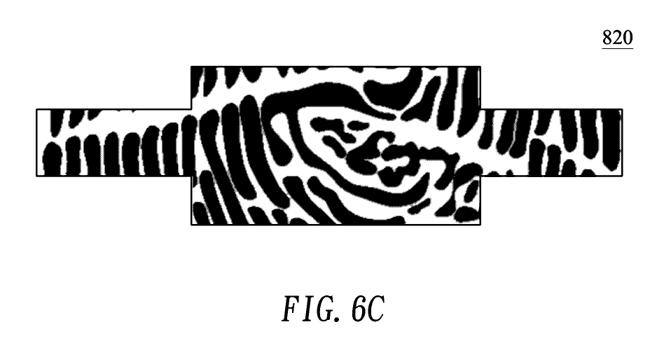

As shown FIG. 6A to FIG. 6C, is an embodiment of a reflection type fingerprint recognition device 100 with 4 light sources 30.

As shown FIG. 6B, the 4 light sources 30, namely light source A, light source B, light source C and light source D, are switched on separately in duration 1, duration 2, duration 3 and duration 4 in sequence and generate 4 fingerprint images 820 separately.

As shown FIG. 6C, the 4 generated fingerprint images 820 are then combined to form a complete fingerprint image 820 for recognition or further processing needs.

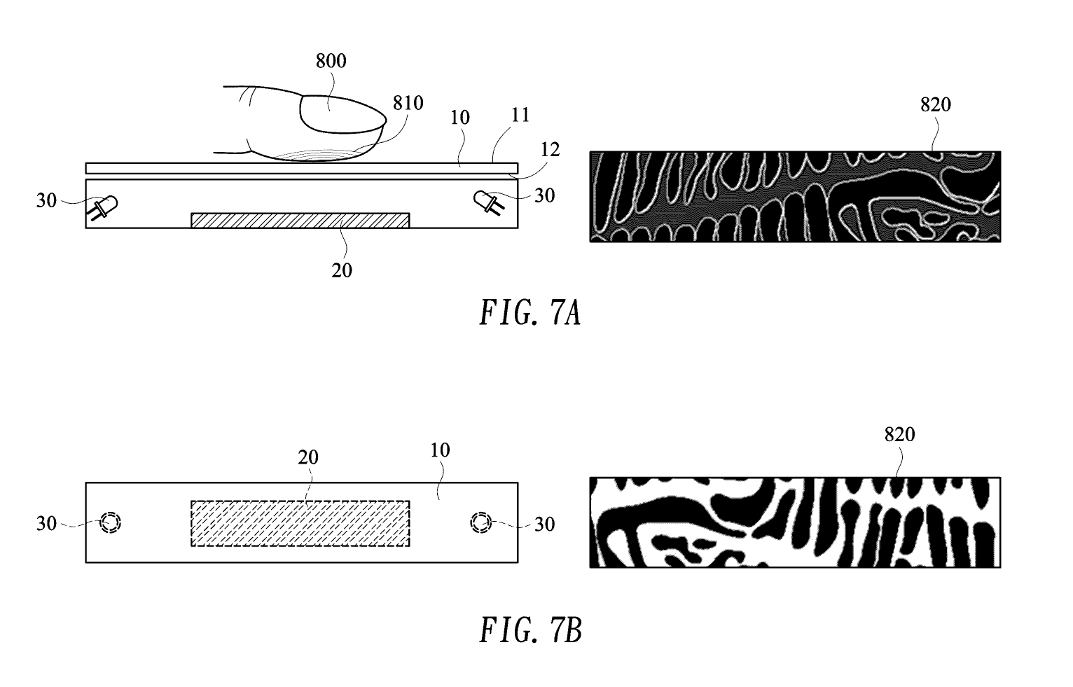

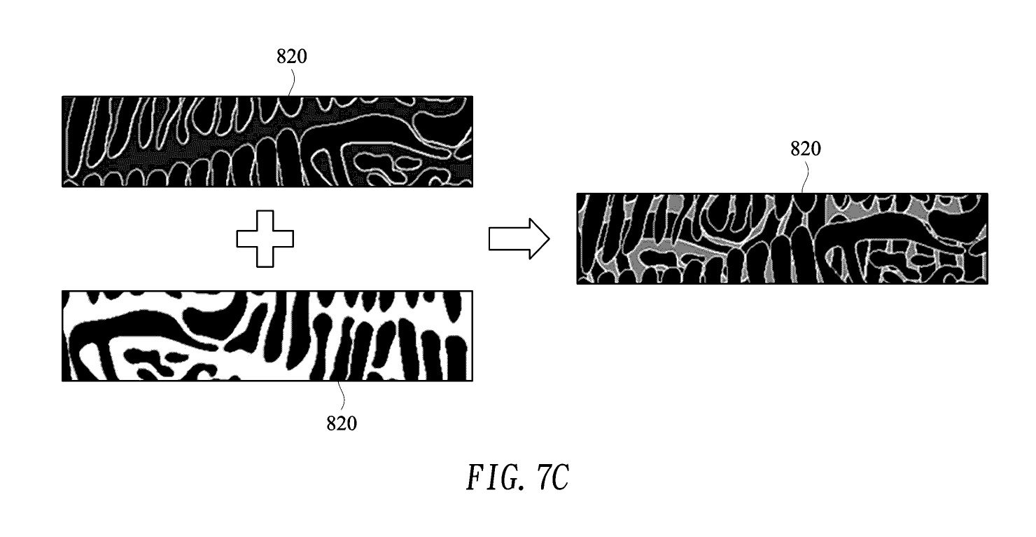

As can be seen in FIG. 7A to FIG. 7C, spatial frequency multiplexing can also be adopted to generate a complete fingerprint image 820.

As shown in FIG. 7A and FIG. 7B, the light sources 30 of the reflection type fingerprint recognition device 100 can be switched on at the same time while emitting different light spectra to the fingerprint 810 of the finger 800 and generate one fingerprint image 820 according to each light spectra.

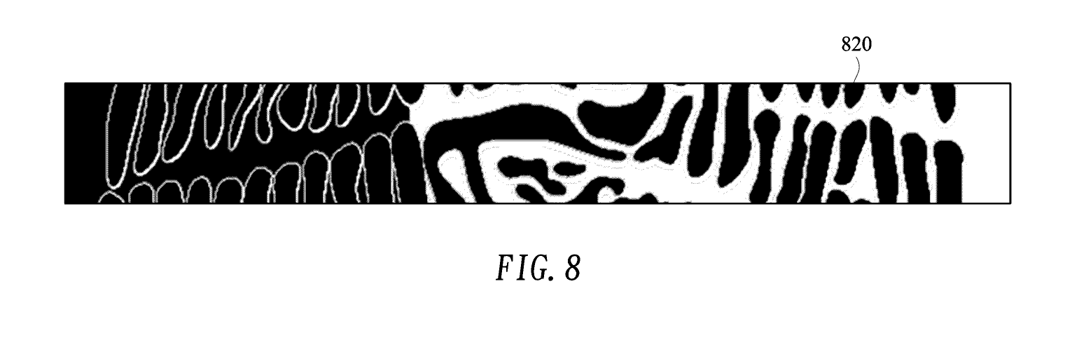

As shown in FIG. 7A to FIG. 8, each fingerprint image 820 generated by each light source 30 illuminating the fingerprint 810 is processed and combined together to generate a complete and correct fingerprint image 820 to be used for recognition or further processing.

Further, with the same processing technique, each of the light sources 30 of the reflection type fingerprint recognition device 100 can also be chosen to emit light of same color but different intensities. That is to say, the emitted light of one of the light sources 30 is of the same color but different intensity from any other light source 30. The fingerprint images 820 generated from such light sources 30 are different from each other and can also be combined to form a complete and correct fingerprint image 820.

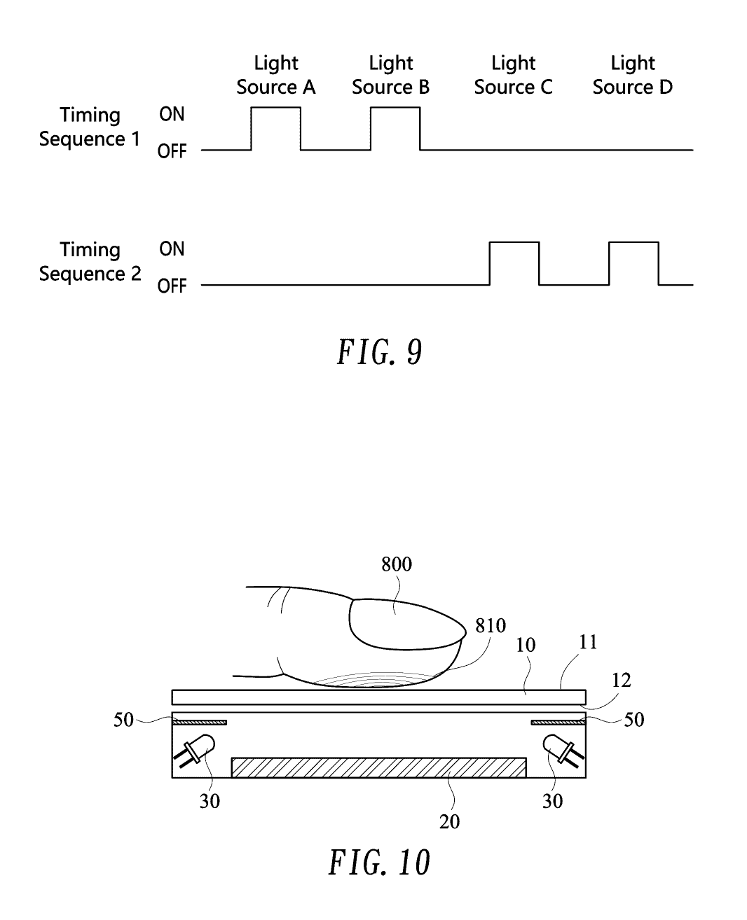

With reference to FIG. 9, is a time saving embodiment of a reflection type fingerprint recognition device 100 with 4 light sources 30. There are only two timing sequences, namely sequence 1 and sequence 2, wherein 2 light sources 30 are switched on in turn in each sequence, 2 fingerprint images 820 are generated and combined. Then the combined fingerprint images 820 of the two timing sequences are combined together to form a complete and correct fingerprint image 820.

It is worth mentioning that the package of any of the light source 30 in foresaid embodiments can be chosen to have small divergence angle, that is, the light emitted from a light source 30 is made a straight beam as possible. A bullet type packaged LED meets the requirement and reduces magnification difference in different illumination area.

Further, as shown in FIG. 10, to prevent the light emitted from the top of a light source 30 illuminates and is reflected by the finger 800 enters the optical sensor 20 to generate unwanted noises, an opaque blocking board 50 is placed in between each light source 30 and the transparent layer 10.

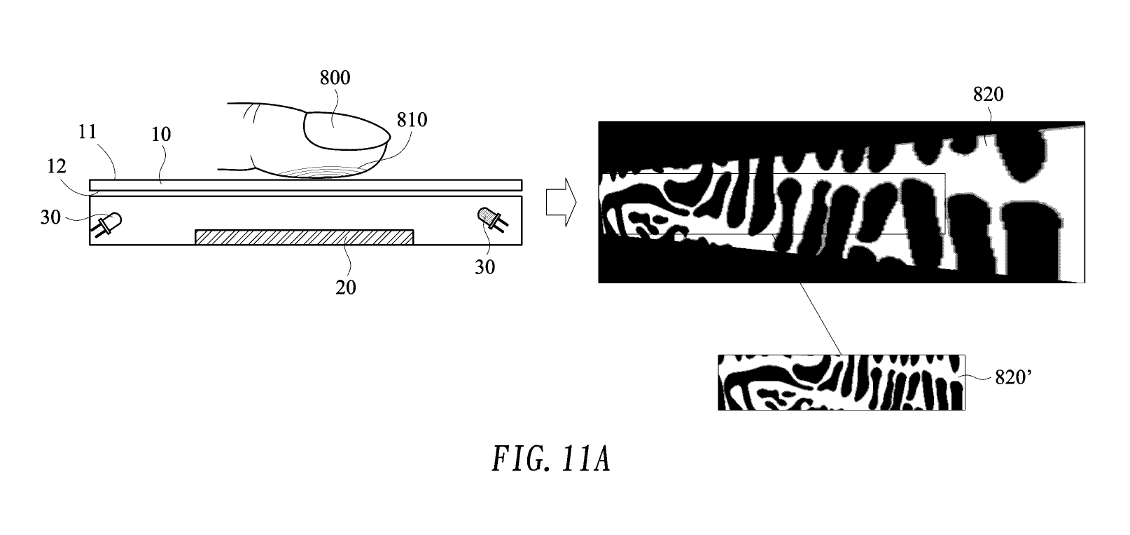

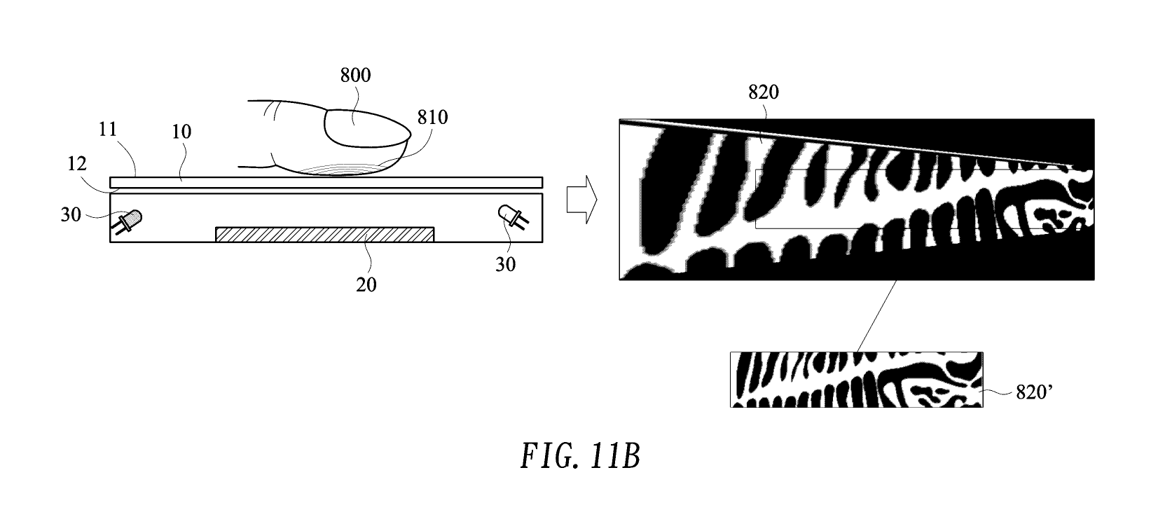

As further shown in FIG. 11A and FIG. 11B, each light source 30 has a specific divergence angle, thus the fingerprint images 820 generated by different illuminating light source 30 can suffer from difference of magnification. However, signal processing techniques can be adopted to filter and correct the magnification difference as in the figures.

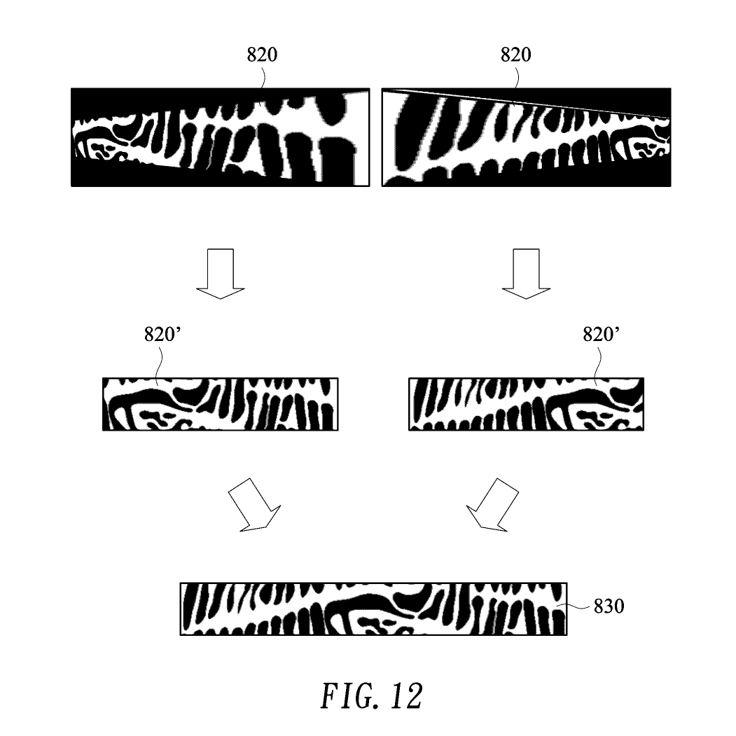

And then, as can be seen in FIG. 12, two corrected fingerprint images 820 without magnification difference is combined and a complete and correct fingerprint image 820 can be obtained for recognition or further processing.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A reflection type fingerprint recognition device, used to sense or recognize a fingerprint, comprising:
a transparent layer, being made of light transmitting substance, a fingerprint of a finger to be recognized being placed on a first surface of the transparent layer;
an optical sensor, fixedly provided beside and without touching a second surface of the transparent layer, wherein the second surface is opposite to the first surface; and
at least two light sources, fixedly provided beside the second surface, wherein the light transmitted from the light sources penetrates the transparent layer and illuminates the fingerprint.

2. The reflection type fingerprint recognition device of claim 1, wherein any of the light source is a LED or a laser diode (LD).

3. The reflection type fingerprint recognition device of claim 1, wherein the light sources being switched on in turn.

4. The reflection type fingerprint recognition device of claim 1, wherein each one of the light sources emitting light of different frequency spectra from any other light source.

5. The reflection type fingerprint recognition device of claim 1, wherein each one of the light sources emitting light of different intensity from any other light source.

6. The reflection type fingerprint recognition device of claim 1, wherein the optical sensor being connected to a processor unit.

7. The reflection type fingerprint recognition device of claim 1, further comprises at least two blocking boards, wherein each of the blocking board is opaque and placed in between each light source and the transparent layer.

8. The reflection type fingerprint recognition device of claim 7, wherein each of the blocking board is of a size relative to the size of a light source.

9. The reflection type fingerprint recognition device of claim 1, wherein the transparent layer being made of glass.

10. The reflection type fingerprint recognition device of claim 1, wherein each of the light sources is a bullet type packaged LED.

11. The reflection type fingerprint recognition device of claim 2, wherein the light sources being switched on in turn.

12. The reflection type fingerprint recognition device of claim 2, wherein each one of the light sources emitting light of different frequency spectra from any other light source.

13. The reflection type fingerprint recognition device of claim 2, wherein each one of the light sources emitting light of different intensity from any other light source.
